(19) United States
(12) Patent Application Publication
(10) Pub. No.: US 2001/0034724 A1
(43) Pub. Date: Oct. 25, 2001

(54) System and method for facilitating secure payment with privacy over a computer network including the internet

(76) Inventor: David Thieme, Monte Carlo (MC)

Correspondence Address: Harry K. Ahn, Esq., BAKER & McKENZIE, 805 Third Avenue, New York, NY, 10022, US

(21) Appl. No.: 09/768,377

(22) Filed: Jan. 22, 2001

Related U.S. Application Data
(60) Provisional application No. 60/177,143, filed on Jan. 20, 2000.

(51) Int. Cl. G06F 17/60; H04K 1/00; H04L 9/00

(52) U.S. Cl. 705/78; 705/64; 705/76; 705/75; 705/39; 705/44

(57) ABSTRACT

A system and method of facilitating a secure transaction is provided. A financial institution of a buyer receives purchase data of a transaction of an item from a transaction facilitator, which acts as an intermediary between the buyer and seller. The financial institution receives a request for payment for the transaction from the buyer. The financial institution associates the buyer with the purchase data of the transaction, and determines whether to approve the transaction. Preferably, the buyer's account identifier such as a credit card or bank card number is not transmitted at any point in the transaction. This allows the transaction to be highly secure.

### CROSS-REFERENCE TO RELATED APPLICATIONS

The present application claims priority from provisional application No. 60/177,143 filed Jan. 20, 2000, which is incorporated herein in its entirety by reference.

### FIELD OF THE INVENTION

The present invention relates to data processing systems, and in particular to a secure online transaction processing system.

### BACKGROUND OF THE INVENTION

Recently, the Internet has exploded as a new market place for offering various types of products and services. One problem that still exists today is that when paying for an item, a buyer must transmit sensitive account information such as a credit card number over an open public network. While some users of the Internet are beginning to feel comfortable about doing so, such sensitive information can nevertheless be intercepted by any computer in the path of the transmission. Another problem is that many online sellers disregard the buyer's privacy rights by employing software tools to track the activities of the buyer, for example by use of cookies and IP addresses.

Accordingly, there is a need to provide a system that enables users of the Internet to enter into commercial transactions for goods and services with more security and privacy protection.

### SUMMARY OF THE INVENTION

According to the principles of the present invention, a system and method of facilitating a secure transaction is provided. A financial institution of a buyer receives purchase data of a transaction of an item from a transaction facilitator, which acts as an intermediary between the buyer and seller. The financial institution receives a request for payment for the transaction from the buyer. The financial institution associates the buyer with the purchase data of the transaction, and determines whether to approve the payment request.

In a preferred embodiment, the buyer's account identifier such as a credit card number, bank account number or bank card number is not transmitted at any point in the transaction. This allows the transaction to be highly secure.

### BRIEF DESCRIPTION OF THE DRAWINGS

FIG. 1 is a diagram illustrating a sequence of activities for processing a transaction according to an exemplary embodiment of the present invention.

FIG. 2 is a detailed flow diagram of a method for facilitating a secure transaction performed by a transaction facilitator according to an exemplary embodiment of the present invention.

FIG. 3 is a detailed flow diagram of a method for facilitating a secure transaction performed by a buyer's financial institution according to an exemplary embodiment of the present invention.

### DETAILED DESCRIPTION OF THE INVENTION

The present transaction facilitation system involves many components. Specifically, it involves a transaction facilitator's central computer 14, seller's computer 12, buyer's computer 10, facilitator's local computer 18 located at a financial institution of the buyer, and a computer 16 of the financial institution. Within each computer, the exemplary transaction facilitation system of the present invention includes a software module that communicates with other computers to complete a business transaction between the buyer and seller.

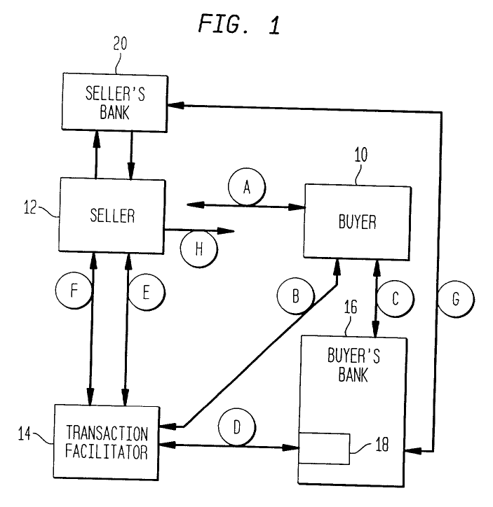

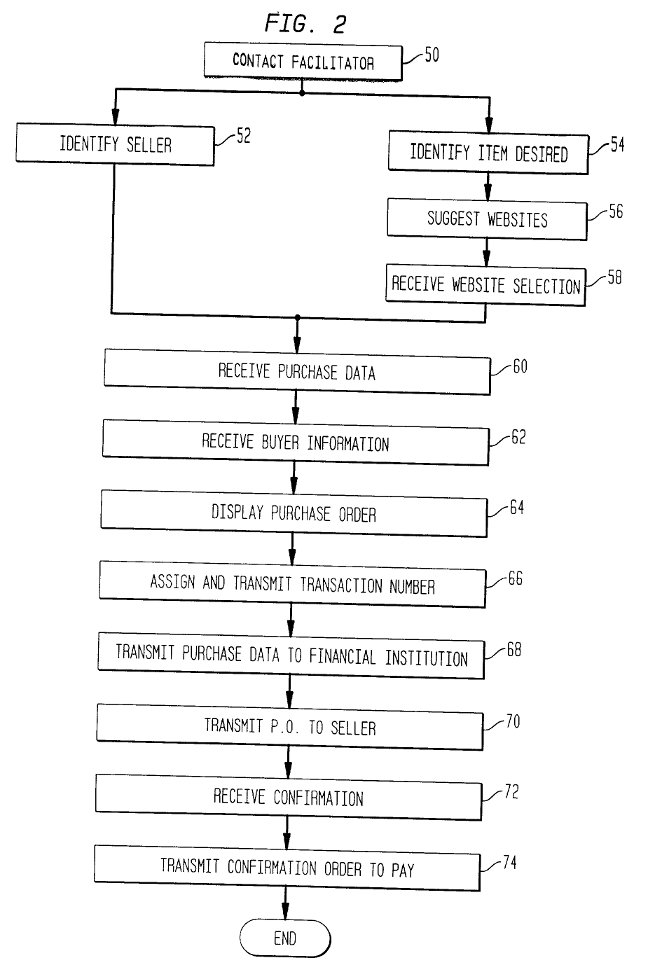

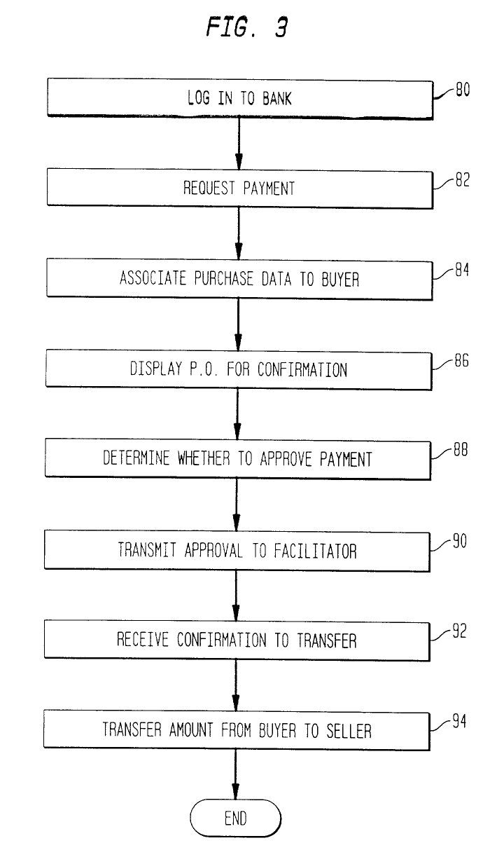

FIG. 1 illustrates a sequence of activities (activities A-H) for processing a transaction according to an exemplary embodiment of the present invention. The activities are described in more detail below with reference to FIGS. 2-3.

In step 50 of FIG. 2, the buyer uses a customized software (not shown) that runs on the buyer's computer 10 to contact the transaction facilitator's central computer 14 to initiate the payment process through, for example, the Internet (activity B in FIG. 1). The customized software allows communication only between the buyer and the facilitator to provide a more private and secure communication. For a first time user/buyer who is accessing the facilitator's website through a commercial browser such as the Internet Explorer from Microsoft Corporation of Redmond, Wash., the buyer is requested to download and install the customized browser software, and contact the facilitator using the customized browser.

In step 52, the buyer provides either the seller's name or the seller's website address. At this point, the buyer has already browsed through the Internet and found an item of product or service at a particular seller's website (activity A).

If the buyer has not already found an item for purchase, a general description of the item desired is provided to the facilitator 14 in step 54. In step 56, the facilitator 14 searches through its database and displays a list of suggested websites that may carry the item desired. In step 58, the buyer selects one seller's website for shopping.

In step 60, the buyer is requested to shop for the item at the selected website as if the buyer were purchasing it directly from the website. In reality, the buyer remains in the facilitator's domain and the seller's website 12 knows nothing about the buyer because the buyer is not in the seller's domain and the seller is communicating only with the facilitator's central computer 14 (activity E). The customized browser provides further privacy protection because it blocks such data seeking program or files as cookies from being deposited into the buyer's computer 10.

When the buyer finishes shopping and clicks on a check out button (not shown), the facilitator retrieves from the seller's domain all relevant purchase data from the shopping cart in step 60. The purchase data may include such data as number of items, item description, unit amount, total amount, or the like.

In step 62, the buyer is requested to provide a delivery address, delivery method, a buyer identifier such as an email address, and a method of future payment such as a credit card, bank card, or direct withdrawal from a financial institution of the buyer. For a credit card, the buyer is requested to provide the type of card (e.g., VISA) and the country of issuance, but not the account identifier (e.g., card number and/or password such as a PIN code). For a bank card, the buyer is requested to provide the name of the financial institution that issued the card and the country of issuance, but again not the account identifier (e.g., bank card number and/or password such as a PIN code). For a direct withdrawal, the buyer is requested to provide the name of the financial institution from which the withdrawal is to be made and the country of the institution, but not the account identifier (e.g., bank account number and/or password such as a PIN code). If payment is to be limited to buyers and sellers of one country, then of course the country information is not necessary. Alternatively or in addition to the above, the buyer may provide the name and address of a third party or independent authorization center that approves transactions on behalf of the buyer's credit or bank card.

In step 64, the facilitator 14 displays a purchase order form with the retrieved purchase data for confirmation by the buyer. Assuming that the buyer has confirmed the purchase, in step 66, the facilitator's central computer 14 assigns and transmits to the buyer's computer 10 a unique transaction number which will guide the transaction until completion. In a preferred embodiment, the transaction number is a combination of current date, current time and random number. If the transaction is aborted for any reason, the assigned number is discarded and not used again. As part of step 66, the buyer is encouraged to save or print the purchase order with the transaction number. Steps 50 through 66 are part of activity B of FIG. 1.

At this stage, the facilitator 14 terminates communication with the buyer's customized browser. The buyer's customized browser then automatically starts the buyer's commercial browser with a website address of the buyer's financial institution for further processing of the transaction. Alternatively, the facilitator 14 terminates communication with the buyer's customized browser and tells the buyer to go to his financial institution's website to request payment for the transaction within a certain time period.

In step 68, the facilitator 14 transmits a portion of the purchase data along with the buyer identifier (activity D) to the financial institution 16 shown as a bank in FIG. 1 through the local computer 18. In the embodiment shown, the facilitator 14 transmits: date and time of the transaction at the facilitator's location, date and time of the transaction at the financial institution's location, assigned transaction number, amount requested, buyer identifier in the form of an email address, and name and website of the seller. The link between the facilitator 14 and the facilitator's local computer 18 is preferably a dedicated private link off the Internet which adds a layer of security and privacy protection.

Referring now to FIG. 3, at about the same time or after the facilitator's central computer 14 has executed step 68, the buyer logs in to his bank's website 16 in step 80 through a communication link (activity C). Preferably, the website is the same site the buyer uses for online banking. The link between the buyer 10 and the buyer's bank 16 is generally a public network such as the Internet. If the financial institution selected by the buyer is a credit card authorization center and the center lacks an interface to the Internet, the facilitator's local computer 18 may provide such an interface to the authorization center 16.

In step 82, the buyer clicks on a payment request button for the facilitator which is part of a software module (not shown) that is installed in the bank's computer 16 by the facilitator 14. In step 84, the bank 16 associates the buyer's account to the purchase data that was transmitted by the facilitator 14 in step 68. In a preferred embodiment, the association is done by matching the buyer's email address stored in the bank's computer 16 to that received from the facilitator 14 through the local computer 18. Alternatively, the association can be done through the transaction number if the buyer supplies the same either manually or automatically by the customized browser.

In step 86, the bank computer 16 displays the purchase data for confirmation by the buyer. If the buyer confirms, then the bank computer determines whether to approve the payment request in step 88. Generally, if the price of the item is within the buyer's credit limit in the case of payment by credit card, or if the price of the item does not exceed the balance in the buyer's account, the bank computer 16 approves the payment request.

In step 90, the bank computer 16 transmits the payment approval to the facilitator's local computer 18 with the following data: type of card if a card is involved, amount, transaction number, name and website of the seller, and date and time of the transaction. The facilitator's local computer 18, in turn, transmits the approval to the facilitator's central computer 14 with the transaction number (activity D).

Referring back to FIG. 2, in step 70, the facilitator 14 transmits a purchase order with the delivery address, transaction number, and card type and the name of the financial institution that approved the payment request to the seller's computer 12 and requests confirmation of the order. Preferably, a software module provided by the facilitator 14 is running on the seller's computer 12 so that much of the interaction can be automated. If the seller determines that the order can be fulfilled, for example by checking to ensure that the item is in stock, it transmits a confirmation with the transaction number which is received by the facilitator 14 in step 72 and ships the item to the buyer (activity H). Upon receiving the confirmation, the facilitator 14 in step 74 transmits to the bank 16 a confirmation order with the transaction number to pay the seller. It is to be noted that when the seller receives the purchase order from the facilitator 14, the seller is assured of payment due to a previous agreement with the facilitator 14 even though the seller may not know the identity of the buyer.

Referring back to FIG. 3, the bank 16 receives the confirmation order in step 92 and transfers the correct amount from the buyer's account to the seller's account 20 in step 94 (activity G) over preferably a private link. Also preferably, the seller's bank 20 and the buyer's bank 16 are two different branches of the same financial institution to provide even more security for the fund transfer.

In one embodiment, the information provided by the buyer during a given transaction such as the buyer's email address and delivery address (other than those required by law and regulation to be kept for a certain number of years) are discarded as soon as the transaction is complete so that maximum privacy of the buyer can be maintained. In an alternative embodiment, however, the facilitation system of the present invention is capable of registering frequent buyers to allow the facilitator 14 to save the buyer information to avoid having to provide the same information for each transaction.

From the foregoing, it will be appreciated that, although specific embodiments of the invention have been described herein for purposes of illustration, various modifications may be made without deviating from the spirit and scope of the invention. For example, while the embodiment disclosed illustrates the use of customized browser software for the buyer's computer, persons of ordinary skill in the art will appreciate that a commercial browser can also be used to contact the facilitator. Accordingly, the present invention is not limited except as by the appended claims.

What is claimed is:

1. A method of facilitating a secure transaction over a computer network, comprising:
receiving, by a financial institution associated with a buyer from a transaction facilitator, purchase data of a transaction of an item;
receiving by the financial institution from the buyer a request for payment for the transaction;
associating by the financial institution the buyer to the purchase data of the transaction; and
determining whether to approve payment request for the transaction by the financial institution.

2. The method according to claim 1 wherein:
in the first receiving step, the purchase data is received through a first link; and
in the second receiving step, the request for payment for the transaction from the buyer is received through a second link different from the first link.

3. The method according to claim 2 wherein the first link is a private link and the second link is the Internet.

4. The method according to claim 1 wherein in the first receiving step, the purchase data is received through a private link.

5. The method according to claim 1 wherein the purchase data includes a buyer identifier and the financial institution associates the buyer to the purchase data through the buyer identifier.

6. The method according to claim 5 wherein the buyer identifier includes an email address of the buyer.

7. The method according to claim 1 wherein the transaction facilitator receives from the buyer an identifier of the financial institution associated with the buyer, the financial institution identifier excluding an account identification information of the buyer.

8. The method according to claim 1, further comprising receiving the purchase data from the website of a seller of the item.

9. The method according to claim 8 wherein the transaction facilitator automatically obtains the price of the item as the buyer shops for the item through the website of the transaction facilitator.

10. The method according to claim 1 wherein the payment request for the transaction is approved by the financial institution if the price of the item is within the credit limit of the buyer, or if the price of the item does not exceed the balance in the account of the buyer.

11. The method according to claim 1, further comprising:
receiving by the transaction facilitator the approval of the payment request for the transaction; and
requesting the seller to ship the item to the buyer.

12. The method according to claim 11, further comprising paying by the financial institution at least a portion of the price of the item by transferring the portion to an account of the seller from the buyer account.

13. A method of facilitating a secure transaction over a computer network, comprising:
receiving by a transaction facilitator purchase data of a transaction of an item while a buyer shops for the item;
transmitting, over a first link, from the transaction facilitator to a financial institution associated with the buyer at least a part of the purchase data and a buyer identifier;
receiving, over a second link, by the financial institution a request for payment for the transaction from the buyer;
associating the buyer to the transaction based on the buyer identifier; and
determining whether to approve the payment request for the transaction by the financial institution.

14. The method according to claim 13 wherein the first link is a private communication link off the Internet and the second link is a communication link through the Internet.

15. A method of facilitating a secure transaction over a computer network, comprising:
under the control of a computer of a transaction facilitator,
receiving purchase data of a transaction of an item from a seller while a buyer shops for the item; and
transmitting over a private communication link to a financial institution associated with the buyer at least a part of the purchase data;
under the control of a computer of the financial institution,
receiving over a public communication link from the buyer a request for payment for the transaction;
associating the buyer to the transaction; and
determining whether to approve the payment request for the transaction.
